(19) United States
(12) Patent Application Publication
(10) Pub. No.: US 2025/0137652 A1
(43) Pub. Date: May 1, 2025

(54) STALL PREVENTION IN COOKTOP APPLIANCE PRECISION MODE WITH TEMPERATURE BAND BASED CONTROL

(71) Applicant: Haier US Appliance Solutions, Inc., Wilmington, DE (US)

(72) Inventor: Omar Santana, Louisville, KY (US)

(21) Appl. No.: 18/497,575

(22) Filed: Oct. 30, 2023

(51) Int. Cl. F24C 7/08; H05B 1/02

(52) U.S. Cl. CPC F24C 7/087; H05B 1/0266

(57) ABSTRACT

A method of operating a cooktop appliance includes receiving a precision cooking mode initiation signal and a setpoint temperature and initiating the precision cooking mode in response to the precision cooking mode initiation signal. The precision cooking mode comprises activating the heating element positioned at the cooking surface. The method also includes monitoring the temperature at the utensil heated by the heating element during the precision cooking mode and operating the heating element at a first predetermined power level when the monitored temperature at the utensil is within a first temperature band of a plurality of temperature bands. The method further includes determining an accumulation term while the monitored temperature at the utensil is within the first temperature band of a plurality of temperature bands and adjusting the operation of the heating element based on the accumulation term.

### FIELD OF THE INVENTION

The present subject matter relates generally to cooktop appliances, including cooktop appliances configured for precise temperature control.

### BACKGROUND OF THE INVENTION

Cooktop appliances generally include heating elements for heating cooking utensils, such as pots, pans and griddles. A user can select a desired heating level, and operation of one or more of the heating elements is modified to match the desired heating level. For example, certain cooktop appliances include electric heating elements. During operation, the cooktop appliance operates the electric heating elements at a predetermined power output corresponding to a selected heating level. As another example, some cooktop appliances include gas burners as heating elements. During operation, the heat output of the gas burner is modulated by adjusting a position of a control valve coupled to the gas burner, e.g., a power level of such heating elements may be or correspond to a control valve position.

Some cooktop appliances are operable in a precision mode, which generally uses a closed loop control algorithm to vary the output of the heating element in response to a target temperature or setpoint temperature and a measured temperature, e.g., of or at the cooking utensil. Some closed loop control algorithms may become stalled, e.g., may reach a steady state that does not satisfy the desired setpoint, such as a steady state error may not be zero. For example, a stall may occur when parameters of the closed loop are designed for conditions different from actual conditions in a cooking operation, such as when a pan size or food load is greater than the design conditions. Thus, typical closed loop algorithms may not produce the optimal or desired results.

Accordingly, a cooktop appliance with features for improved precision temperature control would be useful.

### BRIEF DESCRIPTION OF THE INVENTION

Aspects and advantages of the invention will be set forth in part in the following description, or may be apparent from the description, or may be learned through practice of the invention.

In one example embodiment, a method of operating a cooktop appliance is provided. The cooktop appliance includes a user interface, a heating element positioned at a cooking surface of the cooktop appliance, and a temperature sensor configured to measure a temperature at a utensil heated by the heating element. The method includes receiving a precision cooking mode initiation signal and a setpoint temperature and initiating the precision cooking mode in response to the precision cooking mode initiation signal. The precision cooking mode comprises activating the heating element positioned at the cooking surface. The method also includes monitoring the temperature at the utensil heated by the heating element during the precision cooking mode and operating the heating element at a first predetermined power level when the monitored temperature at the utensil is within a first temperature band of a plurality of temperature bands. The method further includes determining an accumulation term while the monitored temperature at the utensil is within the first temperature band of a plurality of temperature bands and adjusting the operation of the heating element based on the accumulation term.

In another example embodiment, a cooktop appliance includes a user interface. The cooktop appliance also includes a heating element positioned at a cooking surface of the cooktop appliance and a temperature sensor configured to measure a temperature at a utensil heated by the heating element. The cooktop appliance further includes a controller. The controller is configured for receiving a precision cooking mode initiation signal and a setpoint temperature. The controller is also configured for initiating the precision cooking mode in response to the precision cooking mode initiation signal. The precision cooking mode comprises activating the heating element positioned at the cooking surface. The controller is also configured for monitoring the temperature at the utensil heated by the heating element during the precision cooking mode and operating the heating element at a first predetermined power level when the monitored temperature at the utensil is within a first temperature band of a plurality of temperature bands. The controller is further configured for determining an accumulation term while the monitored temperature at the utensil is within the first temperature band of a plurality of temperature bands. The controller is also configured for adjusting the operation of the heating element based on the accumulation term.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, perspective view of a range appliance having a cooktop according to one or more example embodiments of the present subject matter.

FIG. 2 provides a top, plan view of the example appliance of FIG. 1.

FIG. 3 is a schematic top view of an exemplary cooktop according to one or more example embodiments of the present subject matter which may be incorporated into a range appliance such as the range appliance of FIG. 1.

FIG. 4 provides a schematic diagram of a control system as may be used with the exemplary cooktop appliance of FIG. 3.

FIG. 5 provides a schematic diagram of an additional exemplary embodiment of a temperature sensor which may be incorporated into a cooktop appliance in accordance with one or more embodiments of the present subject matter.

FIG. 6 provides an exemplary lookup table for power levels based on temperature bands and temperature setpoints which may be used in one or more exemplary precision cooking operations according to various embodiments of the present disclosure.

FIG. 7 provides an exemplary lookup table of band accumulation factors for temperature bands which may be used in one or more exemplary precision cooking operations according to various embodiments of the present disclosure.

FIG. 8 provides a flow chart illustrating an exemplary method of operating a cooktop appliance according to one or more example embodiments of the present subject matter.

FIG. 9 provides another flow chart illustrating an additional exemplary method of operating a cooktop appliance according to one or more example embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Furthermore, the skilled artisan will recognize the interchangeability of various features from different embodiments. Similarly, the various method steps and features described, as well as other known equivalents for each such methods and features, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

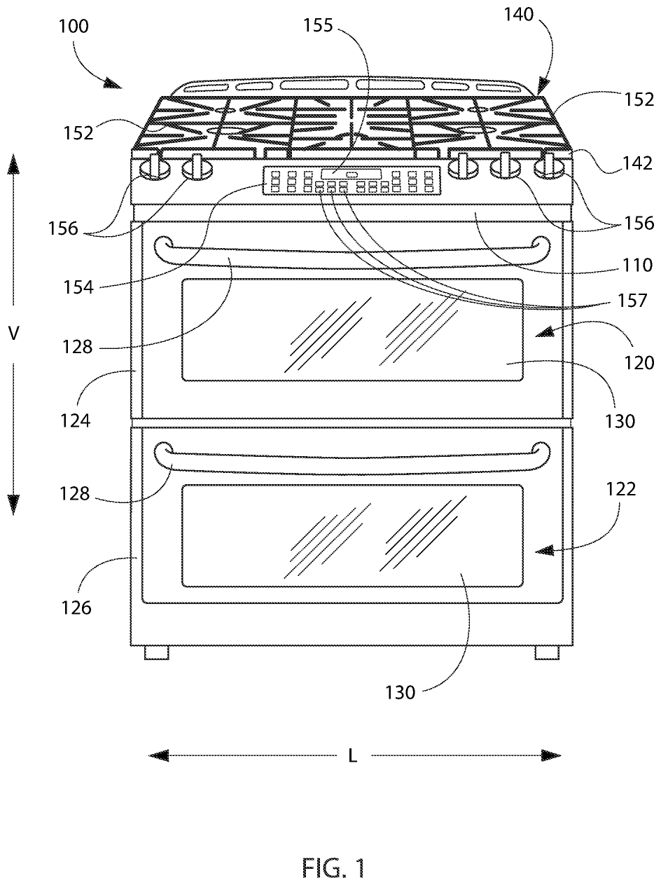

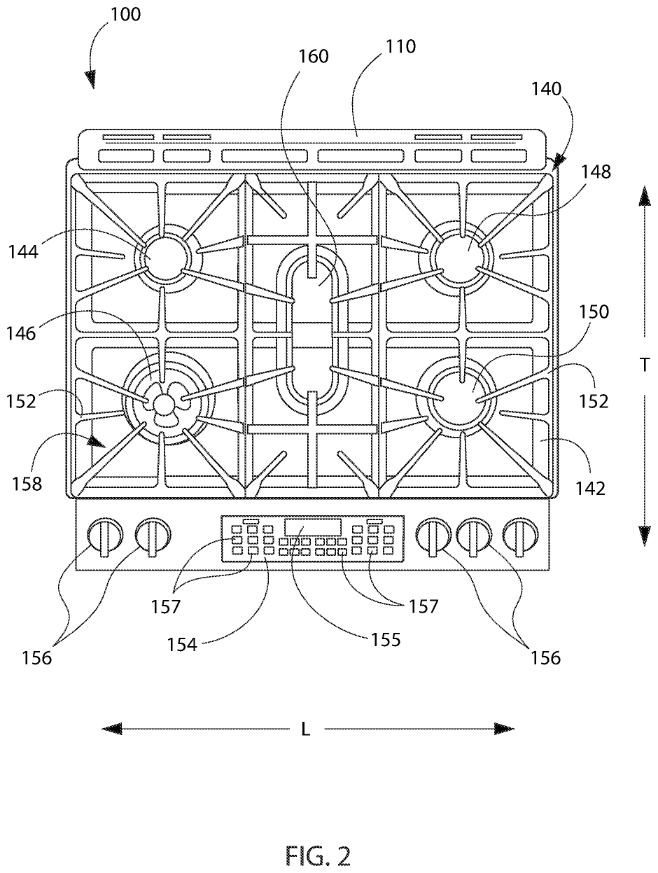

FIG. 1 provides a front, perspective view of a cooktop appliance 100 as may be employed with the present subject matter. FIG. 2 provides a top, plan view of cooktop appliance 100. As illustrated in FIGS. 1 and 2, the example cooktop appliance 100 includes an insulated cabinet 110. Cabinet 110 defines an upper cooking chamber 120 and a lower cooking chamber 122. Thus, this particular exemplary cooktop appliance 100 is generally referred to as a double oven range appliance. As will be understood by those skilled in the art, range appliance 100 is provided by way of example only, and the present subject matter may be used in any suitable cooktop appliance, e.g., a single oven range appliance or a standalone cooktop appliance. In other exemplary embodiments of the present disclosure, the cooktop appliance may include a single cooking chamber, or no cooking chamber at all, such as a standalone cooktop appliance, e.g., which may be built in to a countertop. Thus, the example embodiment shown in FIG. 1 is not intended to limit the present subject matter to any particular cooking chamber configuration or arrangement (or even the presence of a cooking chamber at all, e.g., as in the case of a standalone cooktop appliance).

Upper and lower cooking chambers 120 and 122 are configured for the receipt of one or more food items to be cooked. Cooktop appliance 100 includes an upper door 124 and a lower door 126 rotatably attached to cabinet 110 in order to permit selective access to upper cooking chamber 120 and lower cooking chamber 122, respectively. Handles 128 are mounted to upper and lower doors 124 and 126 to assist a user with opening and closing doors 124 and 126 in order to access cooking chambers 120 and 122. As an example, a user can pull on handle 128 mounted to upper door 124 to open or close upper door 124 and access upper cooking chamber 120. Glass window panes 130 provide for viewing the contents of upper and lower cooking chambers 120 and 122 when doors 124 and 126 are closed and also assist with insulating upper and lower cooking chambers 120 and 122. Heating elements (not shown), such as electric resistance heating elements, gas burners, microwave heating elements, halogen heating elements, or suitable combinations thereof, are positioned within upper cooking chamber 120 and lower cooking chamber 122 for heating upper cooking chamber 120 and lower cooking chamber 122.

Cooktop appliance 100 also includes a cooktop 140. Cooktop 140 is positioned at or adjacent to a top portion of cabinet 110. Thus, cooktop 140 is positioned above upper and lower cooking chambers 120 and 122. Cooktop 140 includes a top panel 142. By way of example, top panel 142 may be constructed of glass, ceramics, stainless steel, enameled steel, and combinations thereof.

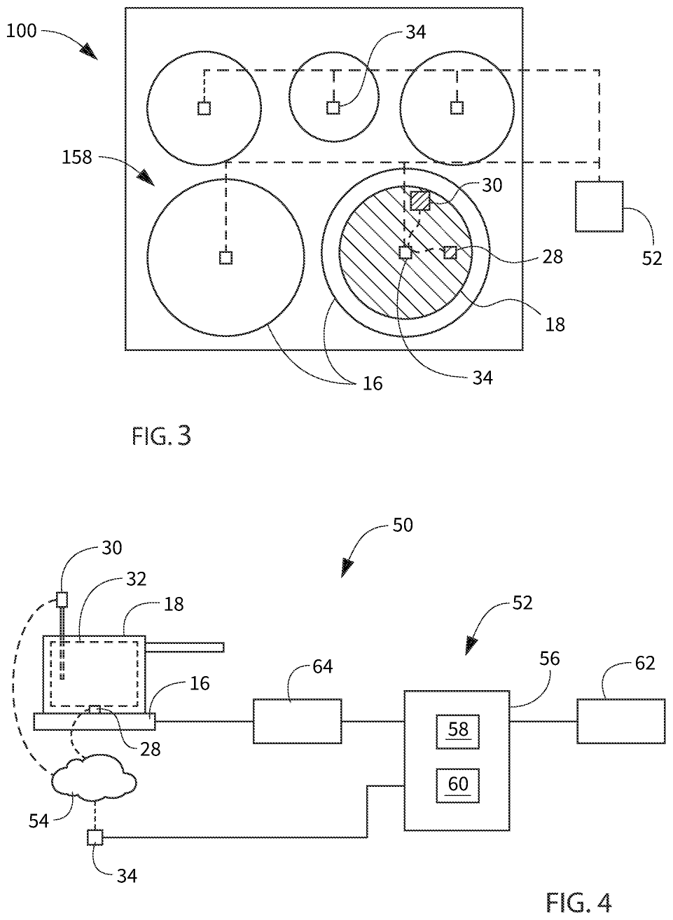

For cooktop appliance 100, a utensil 18 (see, e.g., FIGS. 3, 4, and 5) holding food and/or cooking liquids (e.g., oil, water, etc.) may be placed onto grates 152 at a location of any of burner assemblies 144, 146, 148, 150. Burner assemblies 144, 146, 148, 150 provide thermal energy to cooking utensils on grates 152. As shown in FIG. 2, burner assemblies 144, 146, 148, 150 can be configured in various sizes so as to provide e.g., for the receipt of cooking utensils (i.e., pots, pans, etc.) of various sizes and configurations and to provide different heat inputs for such cooking utensils. Grates 152 are supported on a cooking surface, e.g., top surface 158 of top panel 142. Range appliance 100 also includes a griddle burner 160 positioned at a middle portion of top panel 142, as may be seen in FIG. 2. A griddle may be positioned on grates 152 and heated with griddle burner 160.

A user interface panel 154 is located within convenient reach of a user of the range appliance 100. For this example embodiment, range appliance 100 also includes knobs 156 that are each associated with one of burner assemblies 144, 146, 148, 150 and griddle burner 160. Knobs 156 allow the user to activate each burner assembly and determine the amount of heat input provided by each burner assembly 144, 146, 148, 150 and griddle burner 160 to a cooking utensil located thereon. The user interface panel 154 may also include one or more inputs 157, such as buttons or a touch pad, for selecting or adjusting operation of the range appliance 100, such as for selecting or initiating a precision cooking mode, as will be described in more detail below. User interface panel 154 may also be provided with one or more graphical display devices 155 that deliver certain information to the user such as e.g., whether a particular burner assembly is activated and/or the temperature at which the burner assembly is set.

Although shown with knobs 156, it should be understood that knobs 156 and the configuration of range appliance 100 shown in FIG. 1 is provided by way of example only. More specifically, range appliance 100 may include various input components, such as one or more of a variety of touch-type controls, electrical, mechanical or electro-mechanical input devices including rotary dials, push buttons, and touch pads. The user interface panel 154 may include other display components, such as a digital or analog display device 155, designed to provide operational feedback to a user.

As will be discussed in greater detail below, the cooktop appliance 100 includes a control system 50 (FIG. 4) for controlling one or more of a plurality of heating elements 16. Specifically, the control system 50 may include a controller 52 (FIGS. 3, 4, and 5) operably connected to the user interface panel 154 and controls, e.g., knobs 156. The controller 52 may be operably connected to each of the plurality of heating elements 16 for controlling a power supply and/or flow of gaseous fuel to each of the plurality of heating elements 16 in response to one or more user inputs received through the interface panel 154 and controls.

FIG. 3 is a schematic view of certain components of cooktop appliance 100. In particular, as shown in FIG. 3, cooktop appliance 100 includes a plurality of heating elements 16, which may be gas burners, e.g., as in the exemplary embodiments illustrated in FIGS. 1 and 2 and described above, or may be electric heating elements, such as induction heating elements or resistance heating elements.

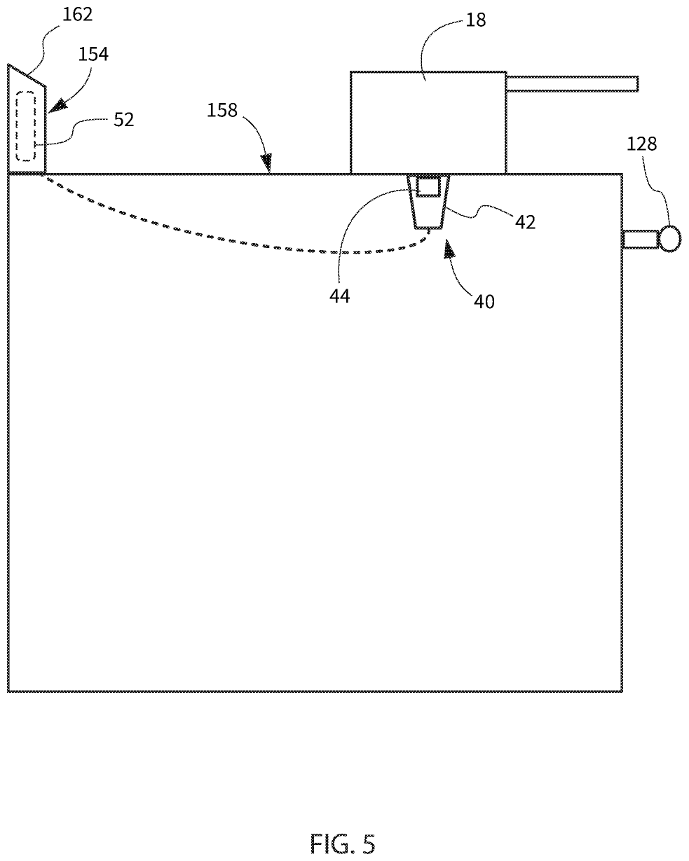

Referring now to FIG. 3, a top, schematic view of a cooktop, which may be, e.g., the cooktop 140 of FIG. 1, is provided. As stated, the cooking surface 158 of the cooktop 140 for the embodiment depicted includes five heating elements 16 spaced along the cooking surface 158. The heating elements 16 may be gas burners, e.g., as illustrated in FIGS. 1 and 2, or may be electric heating elements such as resistance heating elements or induction heating elements, etc. A cooking utensil 18, also depicted schematically, is positioned on a first heating element 16 of the plurality of heating elements 16. As noted above, the cooking utensil 18 may be positioned above the cooking surface 158, e.g., on a grate 152, in embodiments where the heating element 16 is a gas burner. In other embodiments, e.g., where the heating element 16 is a radiant electric heating element or an induction heating element, the cooking utensil 18 may be positioned directly on the cooking surface 158. Further, in embodiments where the heating element 16 is a coil electrical resistance heating element, the cooking utensil 18 may be positioned on the heating element 16. For the embodiment depicted in FIGS. 3 and 4, a cookware temperature sensor 28 and a food temperature sensor 30 are also associated with the cooking utensil 18. In additional embodiments, a temperature sensor may also be integrated into the cooktop, such as a pop-up sensor 40, as illustrated in FIG. 5 and described in further detail below.

In some example embodiments, the cookware temperature sensor 28 may be in contact with, attached to, or integrated into the cooking utensil 18 and configured to sense a temperature of, e.g., a bottom surface of the cooking utensil 18 or bottom wall of the cooking utensil 18. For example, the cookware temperature sensor 28 may be embedded within the bottom wall of the cooking utensil 18 as illustrated in FIG. 3. Alternatively, however, the cookware temperature sensor 28 may be attached to or integrated within the cooking surface 158 of the cooktop appliance 100. For example, the cookware temperature sensor 28 may be integrated into one or more of the heating elements 16, such as pop-up sensor 40 of FIG. 5. With such an exemplary embodiment, the cookware temperature sensor 28 may be configured to physically contact the bottom surface of a bottom wall of the cooking utensil 18 when the cooking utensil 18 is placed on the heating element 16 into which the temperature sensor 28 is integrated. Alternatively, cookware temperature sensor 28 may be positioned proximate to the bottom surface or bottom wall of the cooking utensil 18 when the cooking utensil 18 is placed on the heating element 16.

Additionally, the food temperature sensor 30 may be positioned at any suitable location to sense a temperature of one or more food items 32 (see FIG. 4) positioned within the cooking utensil 18. For example, the food temperature sensor 30 may be a probe type temperature sensor configured to be inserted into one or more food items 32. Alternatively, however, the food temperature sensor 30 may be configured to determine a temperature of one or more food items positioned within the cooking utensil 18 in any other suitable manner.

In certain exemplary embodiments, one or both of the cookware temperature sensor 28 and the food temperature sensor 30 may utilize any suitable technology for sensing/determining a temperature of the cooking utensil 18 and/or food items 32 positioned in the cooking utensil 18. The cookware temperature sensor 28 and the food temperature sensor 30 may measure a respective temperature by contact and/or non-contact methods. For example, one or both of the cookware temperature sensor 28 and the food temperature sensor 30 may utilize one or more thermocouples, thermistors, optical temperature sensors, infrared temperature sensors, resistance temperature detectors (RTD), etc.

Referring again to FIGS. 3 and 4, the cooktop appliance 100 additionally includes at least one receiver 34. In the illustrated example of FIG. 3, the cooktop appliance 100 includes a plurality of receivers 34, each receiver 34 associated with an individual heating element 16. Each receiver 34 is configured to receive a signal from the food temperature sensor 30 indicative of a temperature of the one or more food items 32 positioned within the cooking utensil 18 and/or from the cookware temperature sensor 28 indicative of a temperature of the cooking utensil 18 positioned on a respective heating element 16. In other embodiments, a single receiver 34 may be provided and the single receiver 34 may be operatively connected to one or more of the sensors. In at least some exemplary embodiments, one or both of the cookware temperature sensor 28 and the food temperature sensor 30 may include wireless transmitting capabilities, or alternatively may be hard-wired to the receiver 34, e.g., through a wired communications bus.

FIG. 4 provides a schematic view of a system for operating a cooktop appliance 100 in accordance with an exemplary embodiment of the present disclosure. Specifically, FIG. 4 provides a schematic view of a heating element 16 of the exemplary cooktop appliance 100 of FIGS. 1 and 2 and an exemplary control system 50.

As stated, the cooktop appliance 100 includes a receiver 34 associated with one or more of the heating elements 16, for example a plurality of receivers 34 each associated with a respective heating element 16. For the embodiment depicted, each receiver 34 is positioned directly below a center portion of a respective heating element 16. Moreover, for the embodiment depicted, each receiver 34 is configured as a wireless receiver 34 configured to receive one or more wireless signals. Specifically, for the exemplary control system 50 depicted, both of the cookware temperature sensor 28 and the food temperature sensor 30 are configured as wireless sensors in wireless communication with the wireless receiver 34 via a wireless communications network 54. In certain exemplary embodiments, the wireless communications network 54 may be a wireless sensor network (such as a BLUETOOTH communication network), a wireless local area network (WLAN), a point-to point communication networks (such as radio frequency identification (RFID) networks, near field communications networks, etc.), a combination of two or more of the above communications networks, or any suitable wireless communications network or networks.

Referring still to FIG. 4, each receiver 34 associated with a respective heating element 16 is operably connected to a controller 52 of the control system 50. The receivers 34 may be operably connected to the controller 52 via a wired communication bus (as shown), or alternatively through a wireless communication network similar to the exemplary wireless communication network 54 discussed above. The controller 52 may generally include a computing device 56 having one or more processor(s) 58 and associated memory device(s) 60. The computing device 56 may be configured to perform a variety of computer-implemented functions to control the exemplary cooktop appliance 100. The computing device 56 can include a general purpose computer or a special purpose computer, or any other suitable computing device. It should be appreciated, that as used herein, the processor 58 may refer to a controller, a microcontroller, a microcomputer, a programmable logic controller (PLC), an application specific integrated circuit, and other programmable circuits. Additionally, the memory device(s) 60 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD), and/or other suitable memory elements. The memory 60 can store information accessible by processor(s) 58, including instructions that can be executed by processor(s) 58. For example, the instructions can be software or any set of instructions that when executed by the processor(s) 58, cause the processor(s) 58 to perform operations. For the embodiment depicted, the instructions may include a software package configured to operate the system to, e.g., execute the exemplary methods described below.

Referring again to FIG. 4, the control system 50 additionally includes a user interface 62 operably connected to the controller 52. For the embodiment depicted, e.g., in FIG. 4, the user interface 62 is configured in wired communication with the controller 52. However, in other exemplary embodiments, the user interface 62 may additionally or alternatively be wirelessly connected to the controller 52 via one or more suitable wireless communication networks (such as the exemplary wireless communication network 54 described above). In certain exemplary embodiments, user interface 62 may be configured as the user interface panel 154 and plurality of controls, e.g., knobs 156, on the cooktop appliance 100 (see, e.g., FIG. 1). Additionally, or alternatively, the user interface 62 may be configured as an external computing device or remote user interface device, such as a smart phone, tablet, or other device capable of connecting to the controller 52 of the exemplary control system 50. For example, in some embodiments, the remote user interface may be an application or “app” executed by a remote user interface device such as a smart phone or tablet. Signals generated in controller 52 operate the cooktop appliance 100 in response to user input via the user interface 62.

Further, the controller 52 is operably connected to each of the plurality of heating elements 16 for controlling an operating level, such as a supply of power or a flow of fuel, to each of the plurality of heating elements 16 in response to one or more user inputs through the user interface 62 (e.g., user interface panel 154 and/or controls, e.g., knobs 156). For example, the controller 52 may be operably connected to each of the plurality of heating elements 16 via a plurality of control devices 64, e.g., the controller 52 may be operably connected to the plurality of control devices 64, and each control device 64 may be associated with a respective one of the heating elements 16. In embodiments wherein one or more of the heating elements 16 are configured as electric resistance heaters, the controller 52 may be operably connected to respective relays, triodes for alternating current, or other devices for controlling an amount of power supplied to such electrical resistance heaters, each of which is an exemplary embodiment of control devices 64. Alternatively, in embodiments where one or more of the heating elements 16 are configured as induction heating elements, the controller 52 may be operably connected to respective current control devices, e.g., the control devices 64 operably connected to controller 52 may be respective current control devices for each induction heating element. As another example, in embodiments wherein one or more of the heating elements 16 are configured as gas burners, the control devices 64 may include one or more gas supply valves fluidly coupled to each gas burner for selectively adjusting or restricting, e.g., cutting off, a flow of fuel to each gas burner from a fuel supply.

In some embodiments, e.g., as illustrated in FIG. 5, the cooktop appliance 100 may include a backsplash 162. In such embodiments, the user interface panel 154 may be provided on the backsplash 162.

As mentioned above, in some embodiments a cookware temperature sensor may be attached to or integrated within the cooking surface 158 of the cooktop appliance 100, such as integrated into one or more of the heating elements 16. One example of such embodiments is illustrated in FIG. 5, where a pop-up temperature sensor 40 is integrated into an exemplary one heating element 16 (the heating element itself is not specifically illustrated in FIG. 5 to more clearly depict the pop-up sensor 40) below the cooking surface 158. In particular, the pop-up sensor 40 includes a main body or housing 42 which is fixed in place below the cooking surface 158 and a movable contact temperature probe 44 which is movable, e.g., generally along the vertical direction V, between an extended position (not shown) and a retracted position, as illustrated in FIG. 5, when the probe 44 is in contact with a cooking utensil 18 placed on the cooking surface 158. For example, the pop-up sensor 40 may include a biasing element such as a spring positioned within the housing 42 and positioned between the housing 42 and the probe 44 to bias the probe 44 upwards, e.g., whereby the probe 44 pops up above the cooking surface 158 when a cooking utensil is not present and whereby the weight of a cooking utensil presses the probe downwards, e.g., to or towards the retracted position, when the cooking utensil is present. Thus, for example, the probe 44 of the pop-up temperature sensor 40 may be biased against the bottom outer surface of the cooking utensil 18 when the cooking utensil 18 is placed on or above the heating element 16, such as to promote contact between the probe 44 and the cooking utensil 18 for measurement of the temperature of the cooking utensil 18 by the probe 44.

As mentioned above, the temperature sensor or sensors may be communicatively coupled with the controller 52 by a wired or wireless connection. For example, in the illustrated embodiment of FIG. 5, the pop-up sensor 40 is coupled to the controller 52 by a wired connection. In such embodiments, the receiver 34 described above may be omitted. In additional embodiments, the pop-up sensor 40 of FIG. 5 may be in wireless communication with the controller 52, e.g., in a similar manner as described above with reference to FIGS. 3 and 4.

According to various embodiments of the present disclosure, the cooktop appliance 100 may be configured for a precision cooking mode and/or methods of operating the cooktop appliance 100 may include a precision cooking mode. Precision cooking modes generally include a closed loop control algorithm used to automatically (e.g., without user input such as adjusting the knobs 156) adjust the heating levels of one or more of the heating elements 16. Closed loop control algorithms are generally understood by those of ordinary skill in the art, e.g., wherein temperature measurements are compared to target temperature or setpoint temperature (e.g., user-defined setpoint temperature) to adjust the power level of one or more respective heating elements. Utilizing temperature measurements from one or more of the temperature sensors 28, 30, and/or 40, controller 52 may adjust the control device(s) 64 associated with the heating element 16 currently in use. For example, the user may turn on the closed loop control system by initiating precision cooking mode, such as by pressing or otherwise manipulating a corresponding one of the inputs or controls of the user interface 62. In some embodiments, such inputs and/or controls of the user interface 62 may also be used to input a user-defined setpoint temperature or target temperature for the cooking operation. Additionally or alternatively, such inputs and/or controls of the user interface 62 may also be used to select a food attribute (e.g., type, quantity, volume, etc.), cooking method, or the like, which may be used by the cooking appliance to determine the setpoint temperature for the cooking operation.

When the closed loop control system is activated, controller 52 receives the temperature measurements from temperature sensor 28, 30, and/or 40 and compares the temperature measurements to a target temperature, e.g., the user-defined setpoint temperature or a predetermined target temperature based on a current stage of the precision cooking mode and/or based on a selected food attribute, e.g., type, quantity, volume, etc. In order to reduce a difference between the temperature measurements from the temperature sensor(s) and the target temperature, controller 52 adjusts the respective control device 64. Thus, the heat output provided by the heating element 16 may be regulated by the closed loop control system, e.g., without additional user input and/or monitoring.

A user may establish the setpoint temperature via the user interface 62, e.g., the user interface may include knobs 156, inputs 157, and a display 155, as in the illustrated example embodiment of FIG. 2. Controller 52 is in communication with user interface 62 and is configured to receive the user-determined setpoint temperature from user interface 62. User interface 62 may correspond to user interface panel 154 and/or controls, e.g., knobs 156, in certain example embodiments. Thus, the user may, for example, utilize keys 157 on user interface panel 154 and/or a rotary position of one of the knobs 156 to establish the setpoint temperature and/or input other desired cooking parameters.

In some example embodiments, user interface 62 is positioned on top panel 142 and may be in communication with controller 52 via a wiring harness. As another example, user interface 62 may also or instead correspond to an application on a smartphone or other device, and the user may utilize the application, e.g., to establish the setpoint temperature. In such example embodiments, user interface 62 may be in wireless communication with controller 52, e.g., via a BLUETOOTH® or WI-FI® connection.

Now that the construction of cooktop appliance 100 and the configuration of controller 52 according to exemplary embodiments have been presented, exemplary methods of operating a cooktop appliance will be described. Although the discussion below refers to the exemplary cooktop appliance 100, one skilled in the art will appreciate that the exemplary methods described herein are applicable to the operation of a variety of other cooktop appliances, such as a countertop cooktop appliance and other example cooktop appliances mentioned above as well as other suitable cooktop appliances as will be recognized by those of ordinary skill in the art. In exemplary embodiments, the various method steps as disclosed herein may be performed, e.g., in whole or part, by controller 52 or another, separate, dedicated controller, and/or by one or more remote computing devices, such as in a distributed computing environment, e.g., in the cloud, the fog, or the edge.

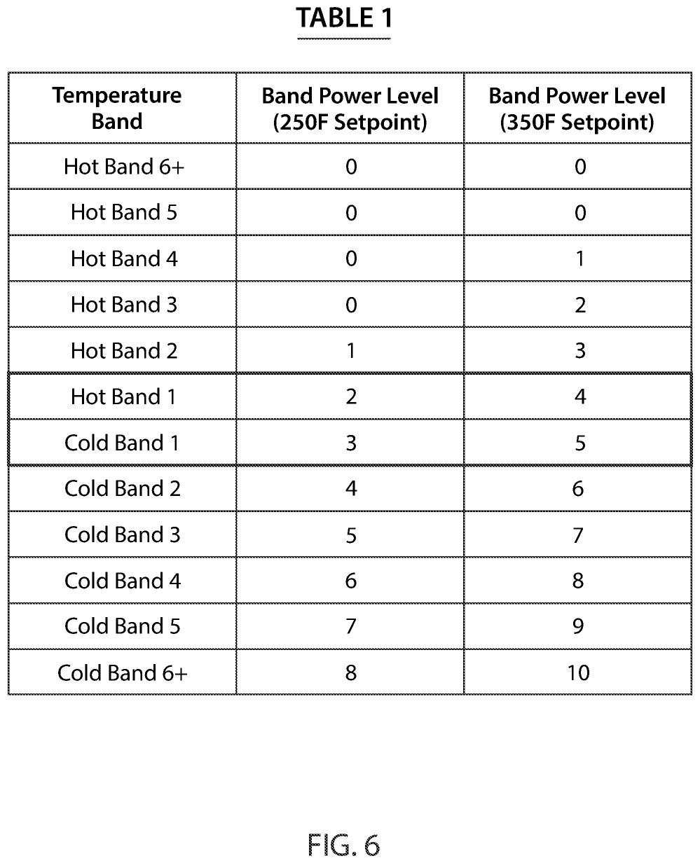

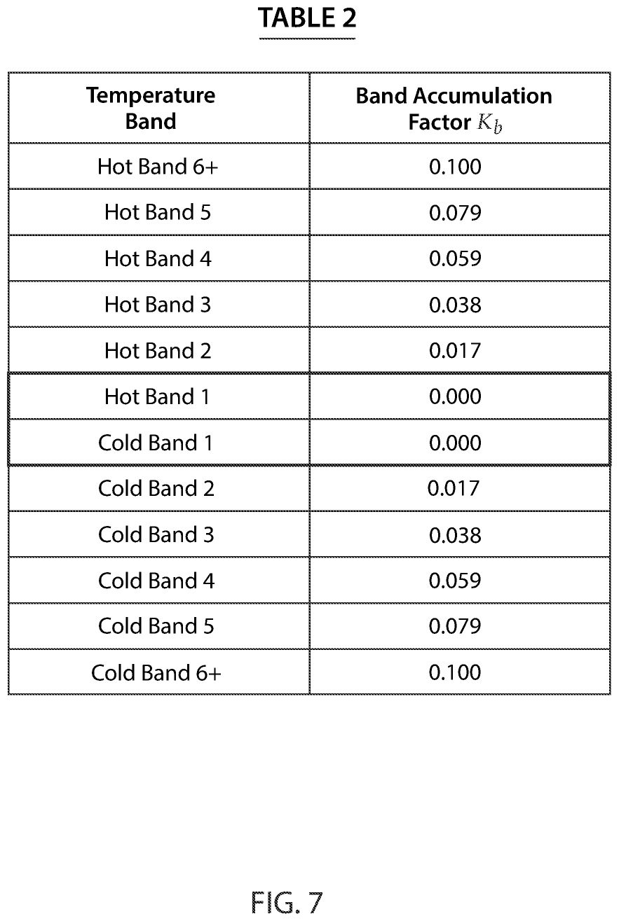

FIG. 6 provides an exemplary lookup table for power levels based on temperature bands and temperature setpoints, which may be user-defined setpoint temperatures, as described above. FIG. 7 provides an exemplary lookup table for band accumulation factors which may be applied, e.g., in determining an accumulation term, in various temperature bands according to exemplary embodiments of the present disclosure. Exemplary values, e.g., of temperature and/or power, are provided in FIGS. 6 and 7 solely for the purposes of discussion and are not intended to limit the present invention in any respect.

Embodiments of the present disclosure include determining, e.g., calculating, an accumulation term for a closed loop cooking control method, such as a temperature band based cooking control method. The temperature band based cooking control method may include a plurality of temperature bands defined relative to the setpoint temperature, such as at least two temperature bands above the setpoint temperature and at least two temperature bands below the setpoint temperature. As illustrated in FIG. 6, in some embodiments, the plurality of temperature bands may include six or more temperature bands above the setpoint temperature (e.g., Hot Bands 1 to 6+, as illustrated in FIG. 6) and six or more temperature bands below the setpoint temperature (e.g., Cold Bands 1 to 6+, as illustrated in FIG. 6). The temperature bands may be defined by equal ranges of temperature, e.g., each successive temperature band may be defined by an increment of temperature from the setpoint temperature, where each increment may be the same as every other increment, such as about ten degrees Fahrenheit (10° F.) or about fifteen degrees Fahrenheit (15° F.), etc. One or more of the temperature bands may have a different width from other temperature bands, such as one or both of the temperature bands adjoining and bounded by the setpoint temperature (e.g., Hot Band 1 and Cold Band 1 illustrated in FIG. 6) may be wider than the other bands, such as one or both of Hot Band 1 and/or Cold Band 1 may encompass a range of about twenty degrees Fahrenheit (20° F.) or about fifteen degrees Fahrenheit (15° F.) from (above or below, respectively) the setpoint temperature, whereas the successive bands (e.g., Hot Bands 2+ and/or Cold Bands 2+) may each encompass a smaller range, such as about fifteen degrees Fahrenheit (15° F.) (when Hot Band 1 and/or Cold Band 1 encompass 20° F. or more) or about ten degrees Fahrenheit (10° F.), etc. For example, Hot Band 1 may extend from the setpoint temperature (“SP”) to SP+15° F., Hot Band 2 may extend from SP+15° F. to SP+25° F., Hot Band 3 may extend from SP+25° F. to SP+35° F., and so forth. The foregoing example may also or instead apply to the cold bands below the setpoint temperature.

In order to avoid a steady state error, e.g., the cooking temperature stalling in a certain temperature band, an accumulation term may be applied. For example, the accumulation term may be applied to the power level called for based on the current temperature band, such as the accumulation term may be used to determine an offset or adjustment to the power level required based on the current temperature, as will be described further below. The accumulation term may be based on one or more of an amount of time a monitored temperature at the utensil has been within a current temperature band, a band accumulation factor proportional to the distance of the current temperature band from the setpoint temperature, and/or a current temperature position factor, in various combinations. For example, the accumulation term may be determined according to the following formula:

$$\begin{matrix}AT = {K}_{b} * TIB * P , where \\ AT : accumulation term \\ {K}_{b} : band accumulation factor [ 1 / sec ] \\ TIB : time in band [ sec ] \\ P : current temperature position ( 1 : below setpoint , - 1 : above setpoint )\end{matrix}$$

After calculating the accumulation term, the operation of the heating element may be adjusted based on the accumulation term. For example, the accumulation term may be applied by using the accumulation term to calculate an adjustment to the power output from the closed loop control, such as the power level adjustment may be added to the power level called for based on the current temperature band. As noted above, the accumulation term may include or be based in part on a current temperature position, such that the accumulation term may be a negative number when the current temperature is above the setpoint temperature, such that adding the adjustment derived from accumulation term to the power level called for based on the current temperature band may (when the accumulation term is significant enough, e.g., has an absolute value greater than or equal to one) result in a lower power level when the current temperature is greater than the setpoint temperature, e.g., is in one of the Hot Bands (FIG. 6). For example, such adjustment of the heating element operation may include calculating a power level adjustment based on the accumulation term (AT), such as according to the following formula:

$$\begin{matrix}{PL}_{adj} = {PL}_{{adj}_{prev}} + AT , where : \\ {PL}_{{adj}_{prev}} : previous value of the power level adjustment \\ {PL}_{adj} : current value of the power level adjustment\end{matrix}$$

Adjustment of the heating element operation may then further include calculating an adjusted power level based on the calculated power level adjustment (PL_{adj}), such as according to the following formula:

$$\begin{matrix}{Pl}_{b} = {PL}_{bt} + {PL}_{adj} , where : \\ {PL}_{bt} : predetermined power level for band ( from lookup table , Table 1 , FIG \text{.6} ) \\ {PL}_{b} : adjusted power level for band\end{matrix}$$

The heating element may then be operated at the adjusted power level determined from the above calculations (PL_{b}), thereby adjusting the operation of the heating element based on the accumulation term.

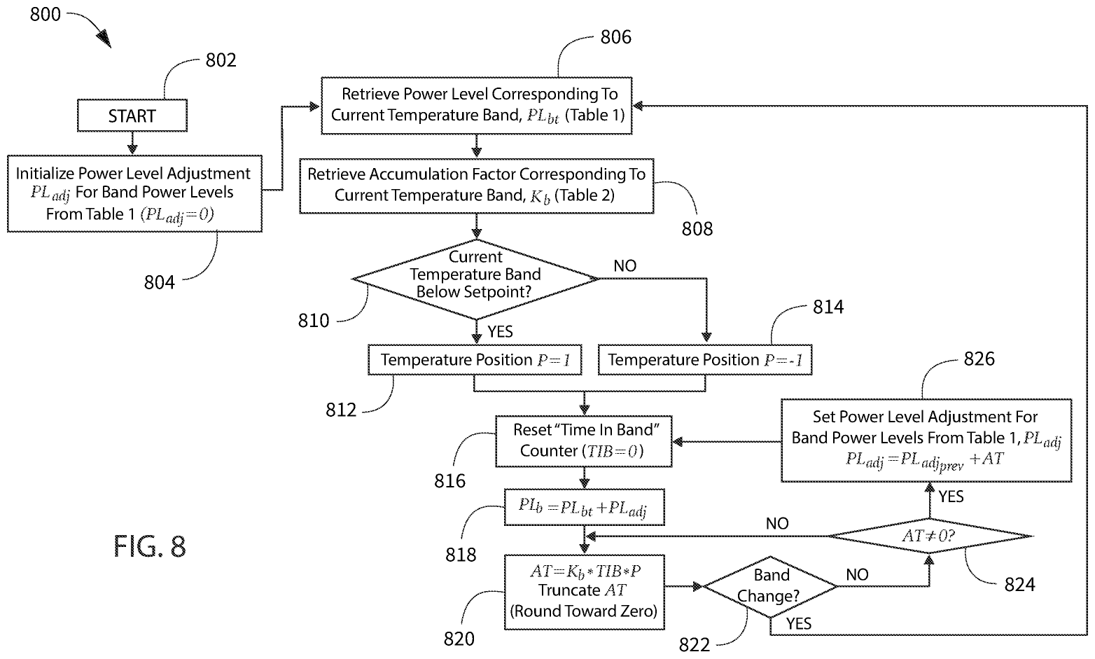

FIG. 8 illustrates an exemplary method 800 of operating a cooktop appliance. As shown in FIG. 8, method 800 begins at (802) and includes initializing (804) a power level adjustment (PL_{adj}) for predetermined power levels associated with each band of a plurality of temperature bands (see, e.g., Table 1 at FIG. 6), where the initial value of PL_{adj} is zero. When the PL_{adj} is zero, the predetermined power levels from the lookup table, e.g., Table 1 in FIG. 6, are applied directly without adjustment or offset, e.g., the heating element is operated at a predetermined power level corresponding to a current temperature band in which the measured temperature at the utensil falls. As shown at (806) in FIG. 8, the predetermined power level for the current temperature band (PL_{bt}) may be retrieved from the table.

Method 800 further includes determining an accumulation term (AT) and calculating a power level adjustment (PL_{adj}) based on the AT. The accumulation term may be based in part on a Band Accumulation Factor (Kb), such as the exemplary Band Accumulation Factors illustrated in Table 2 at FIG. 7. The Kb may have units of seconds to the negative one power, e.g., (1/sec). For example, method 800 may include a process function 808 of retrieving the Band Accumulation Factor (Kb), e.g., from a lookup table such as Table 2, that corresponds to the current temperature band. Method 800 may further include a decision function 810 of determining whether the current temperature band is below the setpoint temperature. Method 800 may further include setting the position factor (P) to a value of one, e.g., as indicated at 812 in FIG. 8, when the current temperature band is below the setpoint temperature, and setting the position factor (P) to a value of negative one, e.g., as indicated at 814 in FIG. 8, when the current temperature band is not below (i.e., is above) the setpoint temperature. The position factor (P) may be unitless.

As shown at 816 in FIG. 8, method 800 may include resetting the time in band (TIB) counter, e.g., setting the value of the TIB to zero. Thus, at the initial iteration of method 800 (e.g., following the initializing function 804) and each time the measured temperature at the utensil crosses into a different temperature band (as may be seen by following the Yes arrow from decision function 822 in FIG. 8, which will be described further below), the TIB is set to zero. The TIB is also set to zero when the power level adjustment (PL_{adj}) changes, as indicated at 826 in FIG. 8. Because the AT is based on the TIB, when the TIB is reset to zero, the AT is also reset to zero. The TIB may be measured in seconds (sec). When TIB is multiplied by the Band Accumulation Factor (Kb, having units of 1/sec), the units cancel out such that the AT is unitless, e.g., the AT is or may be a part of a scaling factor (such as the PL_{adj}) for the heating element power level called for by the closed loop control algorithm, e.g., rather than AT being a quantitative measurement.

Method 800 may further include determining a power level for a current band (PL_{b}) and operating the heating element at the determined PL_{b}. The current band is the temperature band of the plurality of temperature bands in which the currently measured temperature at the cooking utensil is located. As shown at 818, the PL_{b} may be calculated by adding the power level adjustment (PL_{adj}) to the predetermined power level for the current temperature band (PL_{bt}) retrieved from the table. As noted above, the PL_{adj} may be zero initially (e.g., where the PL_{adj} is based on the AT, and AT is zero initially). Thus, method 800 may include, when the monitored temperature at the utensil is within a first temperature band of a plurality of temperature bands, operating the heating element at a first predetermined power level (e.g., the PL_{bt} for the first temperature band, where the PL_{adj} is zero initially and/or after a band change).

When the AT is less than zero, e.g., is negative, the PL_{adj} may also become negative, e.g., when the sum of PL_{adjprev} and AT is less than zero. In such cases, the calculated PL_{b} may be less than a minimum acceptable power level, such as the power level less than zero may not be acceptable and a power level of zero may be the minimum acceptable power level for the control system. Thus, the PL_{b} may be clamped at zero. At the opposite extreme, the PL_{b} may also be clamped at a maximum acceptable power level. That is, when the AT and/or PL_{adjprev} have large values such that the calculated PL_{b} exceeds an upper end of the power level range, the PL_{b} may be clamped at the maximum allowed power level value. For example, the power level range may be from zero to ten (0-10), from zero to nineteen (0-19), from zero to one hundred (0-100), etc.

After operating the heating element at the predetermined power level (PL_{bt}) or at the adjusted power level (PL_{b}), e.g., when the PL_{adj} is not zero, and while the measured temperature at the utensil remains in the same temperature band, the accumulation term (AT) may be calculated, e.g., as indicated at 820 in FIG. 8. For example, AT may be equal to the Band Accumulation Factor (Kb) multiplied by the time in band (TIB) and the position factor (P). The calculated AT may be truncated, e.g., any digits after the decimal may be dropped, and/or may be rounded towards zero (e.g., when greater than zero, always rounded down to the next lower integer and, when less than zero, always rounded up to the next higher integer). Thus, for example, a calculated AT of nine tenths (or ninety-nine hundredths, etc., including any values greater than zero and less than one) would be rounded down to zero, one and nine tenths (1.9) would be rounded down to one, five and nine tenths (5.9) would be rounded down to five, and so forth (including any and all intermediate values between the example values given). As additional examples, a calculated AT of negative nine tenths (−0.9, or negative ninety-nine hundredths (−0.99), etc., including any values greater than negative one and less than zero) would be rounded up to zero, negative one and nine tenths (−1.9) would be rounded up to negative one, and so forth.

Method 800 may then continue with decision function 822 of determining whether a band change has occurred, e.g., whether the measured temperature at the utensil has increased or decreased to the point that the measured temperature reached a different temperature band of the plurality of temperature bands. When there is a band change, e.g., when the result of decision function 822 is positive (“Yes” arrow in FIG. 8), method 800 returns to (806), and proceeds to determine a new value of PL_{b}, where the power level adjustment (PL_{adj}) used to determine the previous value of PL_{b} will become PL_{adjprev} and the power level adjustment (PL_{adj}) used to determine the new value of PL_{b} will be equal to PL_{adjprev}, at least at the initial calculation following a band change. That is, where the PL_{adj} is based on the AT plus the PL_{adjprev}, and the AT includes TIB, which will be reset to zero after the band crossing, thus the AT also goes to zero such that the resultant PL_{adj} is equal to PL_{adjprev} after the band crossing, such as at least immediately after the band crossing. Accordingly, the power level adjustment (PL_{adj}) maintains its latest calculated value after a temperature band crossing, so that any power level adjustment from a previous temperature band is retained throughout the precision cooking operation. This will effectively adjust the cooking algorithm (e.g., adjust the power level for all temperature bands), for example, when a pan size or food load are different from design conditions.

When there is not a band change, e.g., when the result of decision function 822 is negative (“No” arrow in FIG. 8), method 800 continues to decision function 824 of determining whether the AT is not equal to zero (specifically, whether the AT which was calculated and then truncated and/or rounded towards zero is not equal to zero). For example, the AT may not be equal to zero when the AT is greater than zero, such as one or another greater integer (the AT having only integer values as a result of truncation and/or rounding towards zero), or when the AT is less than zero, such as negative one or another lesser integer. When the AT is equal to zero, method 800 returns to process function 820 and calculates a new value of AT, e.g., based on the updated TIB as the measured temperature has remained in the same band.

As shown at (826) in FIG. 8, when the AT is not equal to zero, method 800 may include setting a power level adjustment for the predetermined power levels at each temperature band, e.g., determining the power level adjustment (PL_{adj}) from a stored previous power level adjustment (PL_{adjprev}) plus the AT. Also, it should be understood that the previous power level adjustment (PL_{adjprev}) is retained throughout the cooking operation, whereas the AT may be reset, e.g., when there is a band change. Thus, once the AT has reached a non-zero value, a PL_{adj} will be calculated, the TIB (and thus the AT also) will be reset to zero, and all future power level adjustments will have the calculated power level adjustments built in via the previous power level adjustment (PL_{adjprev}) term.

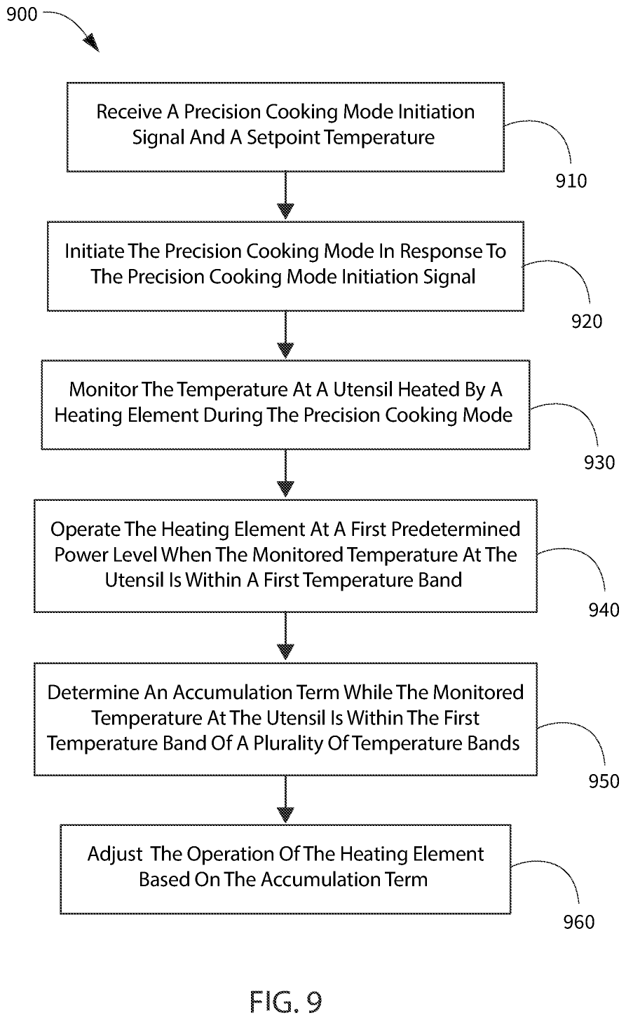

Turning now to FIG. 9, an example method 900 of operating a cooktop appliance, such as the example appliance 100 described above, is illustrated. Thus, the cooktop appliance which is operated according to the exemplary method 900 may include a user interface, a heating element positioned at a cooking surface of the cooktop appliance, and a temperature sensor configured to measure a temperature at a utensil heated by the heating element. The method 900 may include receiving a precision cooking mode initiation signal, e.g., from a user interface, such as user interface 62, of the cooktop appliance, as indicated at (910) in FIG. 9.

The precision cooking mode initiation signal may be received from the user interface, e.g., user interface panel 154 and/or knobs 156. The precision cooking mode initiation signal may represent or correspond to a user request for the precision cooking mode based on a user pressing a precision cooking mode key or button 157 or otherwise entering the request via the user interface 62. The precision cooking mode may utilize a closed loop control system in at least one stage of the precision cooking mode, where the closed loop control system may operate or adjust the cooktop appliance, e.g., power levels of one or more heating elements of the cooking appliance, based on input from a temperature sensor.

The precision cooking mode initiation signal (and, in at least some embodiments, a setpoint temperature) may be received from one or more of a user interface on the cooktop appliance and/or a remote user interface device. In exemplary embodiments where such inputs are also or instead received via the remote user interface device, the remote user interface device may be any suitable device such as a laptop computer, smartphone, tablet, personal computer, wearable device, smart speaker, smart home system, and/or various other suitable devices. The remote user interface device is “remote” at least in that it is spaced apart from and not physically connected to the cooktop appliance, e.g., the remote user interface device is a separate, stand-alone device from the cooktop appliance which communicates with the cooktop appliance wirelessly, e.g., through various possible communication connections and interfaces such as WI-FI®. The cooktop appliance and the remote user interface device may be matched in wireless communication, e.g., connected to the same wireless network. The cooktop appliance may communicate with the remote user interface device via short-range radio such as BLUETOOTH® or any other suitable wireless network having a layer protocol architecture. Any suitable device separate from the cooktop appliance that is configured to provide and/or receive communications, information, data, or commands from a user may serve as the remote user interface device, such as a smartphone, smart watch, personal computer, smart home system, or other similar device. For example, the remote user interface device may be a smartphone operable to store and run applications, also known as “apps,” and some or all of the method steps disclosed herein may be performed by a smartphone app.

As illustrated in FIG. 9, exemplary embodiments of the method 900 may also include (920) initiating the precision cooking mode in response to the precision cooking mode initiation signal. The precision cooking mode may include activating the heating element positioned at the cooking surface. Method 900 may further include (930) monitoring the temperature at the utensil heated by the heating element during the precision cooking mode. Activating the heating element positioned at the cooking surface during the precision cooking mode may further include (940) operating the heating element at a first predetermined power level when the monitored temperature at the utensil is within a first temperature band of a plurality of temperature bands.

Method 900 may further include (950) determining an accumulation term while the monitored temperature at the utensil is within the first temperature band of the plurality of temperature bands. The accumulation term may be based, at least in part, on the amount of time the current temperature has remained within the first temperature band, a band accumulation factor that is proportional to the distance of the first temperature band from the setpoint temperature, and/or a current temperature position factor which reflects whether the first temperature band is above or below the setpoint temperature.

Method 900 may then include (960) adjusting the operation of the heating element based on the accumulation term. Adjusting operation of the heating element may include adjusting the power level of the heating element. As mentioned above, the heating element, e.g., heating element 16, may be any suitable type of heating element. For example, in some embodiments, the heating element may be or include a gas burner. In such embodiments, the power level of the heating element, e.g., which may be determined by the closed loop control algorithm, such as based on the temperature bands, may correspond to a position of a fuel supply valve coupled to the gas burner. As another example, in additional embodiments, the heating element may also or instead be or include an electric heating element. In such embodiments, the power level of the heating element may correspond to a level of electric power supplied to the heating element. In some embodiments, adjusting the operation of the heating element based on the accumulation term may include determining a power level adjustment based on the accumulation term and applying the power level adjustment to a predetermined power level called for based on the first temperature band.

In some embodiments, the accumulation term may be based on a current temperature position factor. As mentioned above, the current temperature position factor may be positive when the monitored temperature at the utensil heated by the heating element is less than the setpoint temperature, and the current temperature position factor may be negative when the monitored temperature at the utensil heated by the heating element is greater than the setpoint temperature.

In some embodiments, the first temperature band may be a first temperature band of the cooking operation, e.g., may occur at the beginning of the cooking operation, such as at the start of a precision cooking operation following a preheat time or preheat phase. Thus, the first temperature band may adjoin and be bounded by the setpoint temperature, such as the preheat phase may end and the precision cooking may begin when the measured temperature at the utensil is relatively close to the setpoint temperature, e.g., is within a temperature band adjoining the setpoint temperature. In additional embodiments, the first temperature band is not necessarily the first in time over the precision cooking operation as a whole. In some embodiments, the first temperature band may be separated from the setpoint temperature by at least one intervening temperature band of the plurality of temperature bands, such as the first temperature band may be Hot Band 2 (FIG. 6) or higher temperature, or the first temperature band may be Cold Band 2 (FIG. 6) or lower temperature.

In some embodiments, adjusting the operation of the heating element based on the accumulation term may include adjusting a power level when an absolute value of the determined accumulation term is greater than or equal to one. For example, when the accumulation term, such as a truncated and/or rounded towards zero accumulation term, is one or greater, or is negative one or less, the accumulation term may be used to calculate a power level adjustment, and the power level of the heating element may be adjusted, e.g., from the predetermined power level for the current temperature band in FIG. 6, based on the power level adjustment.

In some embodiments, when the absolute value of the determined accumulation term is greater than or equal to one, exemplary methods may include truncating the accumulation term to an integer, and determining a required power level based on the truncated accumulation term and the first predetermined power level. For example, the required power level may be determined based on a power level adjustment calculated from the accumulation term which is then added to the first predetermined power level that corresponds to the current temperature band, e.g., in a lookup table such as Table 1 in FIG. 6.

As mentioned above, the power level adjustment may be retained, e.g., stored in a memory such as a memory 60 of controller 52, and applied throughout the precision cooking operation. For example, exemplary methods may include storing the power level adjustment in a memory of the controller and, when the monitored temperature at the utensil is within a second temperature band of the plurality of temperature bands, operating the heating element at a power level determined by the stored power level adjustment and a second predetermined power level corresponding to the second temperature band. For example, operating the heating element at a power level determined by the stored power level adjustment and a second predetermined power level corresponding to the second temperature band may include adding the stored power level adjustment to the predetermined power level from the lookup table (e.g., Table 1 in FIG. 6).

In some embodiments, exemplary methods may include operating the heating element at a second predetermined power level when the monitored temperature at the utensil is within a second temperature band of a plurality of temperature bands prior to the monitored temperature at the utensil being within the first temperature band. Such embodiments may also include determining the accumulation term while the monitored temperature at the utensil is within the second temperature band, and resetting the accumulation term (e.g., setting the accumulation term to zero, such as resetting the time in band factor to zero) when the monitored temperature at the utensil moves from the second temperature band to the first temperature band. Thus, the accumulation term may be repeatedly calculated throughout the precision cooking and may be reset at each band crossing in any direction (e.g., up or down, such as increase or decrease in the measured temperature at the utensil above or below the limit of one temperature band).

The accompanying FIGS., e.g., FIGS. 8 and 9, depict steps performed in a particular order for purpose of illustration and discussion. Those of ordinary skill in the art, using the disclosures provided herein, will understand that the steps of the methods 800 and/or 900 can be modified, adapted, rearranged, omitted, interchanged, or expanded in various ways without deviating from the scope of the present disclosure. Referring generally to FIGS. 8 and 9, the methods 800 and 900 may be interrelated and/or may have one or more steps from one of the methods 800 and 900 combined with one or more other method(s) 800 or 900. Thus, those of ordinary skill in the art will recognize that the various steps of the exemplary methods described herein may be combined in various ways to arrive at additional embodiments within the scope of the present disclosure. Those of ordinary skill in the art, using the disclosures provided herein, will understand that (except as otherwise indicated) methods 800 and 900 are not mutually exclusive. Moreover, the steps of the methods 800 and 900 can be modified, adapted, rearranged, omitted, interchanged, or expanded in various ways without deviating from the scope of the present disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a cooktop appliance, the cooktop appliance comprising a user interface, a heating element positioned at a cooking surface of the cooktop appliance, and a controller in communication with a temperature sensor configured to measure a temperature at a utensil heated by the heating element, the method comprising:
receiving a precision cooking mode initiation signal and a setpoint temperature;
initiating the precision cooking mode in response to the precision cooking mode initiation signal, wherein the precision cooking mode comprises activating the heating element positioned at the cooking surface;
monitoring the temperature at the utensil heated by the heating element during the precision cooking mode;
operating the heating element at a first predetermined power level when the monitored temperature at the utensil is within a first temperature band of a plurality of temperature bands;
determining an accumulation term while the monitored temperature at the utensil is within the first temperature band of the plurality of temperature bands; and
adjusting the operation of the heating element based on the accumulation term.

2. The method of claim 1, wherein the accumulation term is based on an amount of time the monitored temperature at the utensil has been within the first temperature band.

3. The method of claim 1, wherein the accumulation term is based on a band accumulation factor proportional to a distance of the first temperature band from the setpoint temperature.

4. The method of claim 1, wherein the accumulation term is based on a current temperature position factor.

5. The method of claim 4, wherein the current temperature position factor is positive when the monitored temperature at the utensil heated by the heating element is less than the setpoint temperature.

6. The method of claim 4, wherein the current temperature position factor is negative when the monitored temperature at the utensil heated by the heating element is greater than the setpoint temperature.

7. The method of claim 1, wherein the first temperature band is separated from the setpoint temperature by at least one intervening temperature band of the plurality of temperature bands.

8. The method of claim 1, wherein adjusting the operation of the heating element based on the accumulation term comprises adjusting a power level when an absolute value of the determined accumulation term is greater than or equal to one.

9. The method of claim 8, further comprising, when the absolute value of the determined accumulation term is greater than or equal to one, truncating the accumulation term to an integer, and determining a required power level based on the truncated accumulation term and the first predetermined power level.

10. The method of claim 9, further comprising storing a power level adjustment in a memory of the controller and, when the monitored temperature at the utensil is within a second temperature band of the plurality of temperature bands, operating the heating element at a power level determined by the stored power level adjustment and a second predetermined power level corresponding to the second temperature band.

11. The method of claim 1, further comprising operating the heating element at a second predetermined power level when the monitored temperature at the utensil is within a second temperature band of a plurality of temperature bands prior to the monitored temperature at the utensil being within the first temperature band, determining the accumulation term while the monitored temperature at the utensil is within the second temperature band, and resetting the accumulation term when the monitored temperature at the utensil moves from the second temperature band to the first temperature band.

12. A cooktop appliance, comprising:
a user interface;
a heating element positioned at a cooking surface of the cooktop appliance; and
a controller in communication with a temperature sensor configured to measure a temperature at a utensil heated by the heating element, the controller configured for:
receiving a precision cooking mode initiation signal and a setpoint temperature;
initiating the precision cooking mode in response to the precision cooking mode initiation signal, wherein the precision cooking mode comprises activating the heating element positioned at the cooking surface;
monitoring the temperature at the utensil heated by the heating element during the precision cooking mode;
operating the heating element at a first predetermined power level when the monitored temperature at the utensil is within a first temperature band of a plurality of temperature bands;
determining an accumulation term while the monitored temperature at the utensil is within the first temperature band of a plurality of temperature bands; and
adjusting the operation of the heating element based on the accumulation term.

13. The cooking appliance of claim 12, wherein the accumulation term is based on an amount of time the monitored temperature at the utensil has been within the first temperature band.

14. The cooking appliance of claim 12, wherein the accumulation term is based on a band accumulation factor proportional to a distance of the first temperature band from the setpoint temperature.

15. The cooking appliance of claim 12, wherein the accumulation term is based on a current temperature position factor.

16. The cooking appliance of claim 12, wherein the first temperature band is separated from the setpoint temperature by at least one intervening temperature band of the plurality of temperature bands.

17. The cooking appliance of claim 12, wherein adjusting the operation of the heating element based on the accumulation term comprises adjusting a power level when an absolute value of the determined accumulation term is greater than or equal to one.

18. The cooking appliance of claim 17, wherein the controller is further configured for, when the absolute value of the determined accumulation term is greater than or equal to one, truncating the accumulation term to an integer, and determining a required power level based on the truncated accumulation term and the first predetermined power level.

19. The cooking appliance of claim 18, wherein the controller is further configured for storing a power level adjustment in a memory of the controller and, when the monitored temperature at the utensil is within a second temperature band of the plurality of temperature bands, operating the heating element at a power level determined by the stored power level adjustment and a second predetermined power level corresponding to the second temperature band.

20. The cooking appliance of claim 12, wherein the controller is further configured for operating the heating element at a second predetermined power level when the monitored temperature at the utensil is within a second temperature band of a plurality of temperature bands prior to the monitored temperature at the utensil being within the first temperature band, determining the accumulation term while the monitored temperature at the utensil is within the second temperature band, and resetting the accumulation term when the monitored temperature at the utensil moves from the second temperature band to the first temperature band.
